(19) United States
(12) Patent Application Publication
(10) Pub. No.: US 2026/0148460 A1
(43) Pub. Date: May 28, 2026

(54) METHOD FOR PROCESSING DIGITAL HUMAN EXPRESSION, ELECTRONIC DEVICE, AND STORAGE MEDIUM

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XIANG HUANG, Shenzhen (CN)

(21) Appl. No.: 19/089,298

(22) Filed: Mar. 25, 2025

(30) Foreign Application Priority Data
Nov. 28, 2024 (CN) 202411749878.5

(51) Int. Cl. G06T 13/40; G06F 3/01; G06T 7/60; G06V 40/16

(52) U.S. Cl. CPC G06T 13/40; G06F 3/013; G06T 7/60; G06V 40/176

(57) ABSTRACT

A method for processing a digital human expression is provided by present application. The method includes obtaining first information of a user, obtaining second information of the user, acquiring corresponding expression information based on the second information, and generating the digital human expression corresponding to the user according to the first information, the second information, and the expression information. The method may improve interactive effect of electronic devices.

### FIELD

The object to be tested matter herein generally relates to a field of artificial intelligence, and in particular to a method for processing a digital human expression, an electronic device and a storage medium.

### BACKGROUND

With development of computer hardware technology and computer vision technology, current digital human technology has developed rapidly. As an important part of the metaverse, a digital human is also used as an interactive interface with artificial intelligence. This technology has also been applied in many scenarios, including virtual customer service, virtual teachers, and virtual anchors. A virtual digital human is a virtual character with a digital appearance. They are innovative “new species” formed by an integration of computer graphics (CG) technology, motion capture, graphics rendering, holographic projection, and artificial intelligence. The most important thing about the virtual digital human is the interactive function. However, in interactive scenarios such as video communication, the digital human generated by existing technology may synchronously update information of the eyes and mouth, which seriously affects the interactive effect.

### BRIEF DESCRIPTION OF THE DRAWINGS

FIG. 1 is a schematic diagram of an application scenario of a method for processing a digital human expression provided in an embodiment of the present application.

FIG. 2 is a structural diagram of an electronic device provided in an embodiment of the present application.

FIG. 3 is a schematic diagram of a digital human expression provided in an embodiment of the present application.

FIG. 4 is a flowchart of a method for processing a digital human expression provided in an embodiment of the present application.

FIG. 5 is a schematic diagram of a structure of an apparatus for processing a digital human expression provided in an embodiment of the present application.

### DETAILED DESCRIPTION

To facilitate understanding, some illustrations of concepts related to the embodiments of the present application are given by way of example for reference.

It should be noted that in the present application, “at least one” means one or more, and “more than one” means two or more than two. “And/or” in the present application is only a description of an association relationship of associated objects, indicating that three relationships exist. For example, A and/or B may represent: A exists alone, A and B exist at the same time, and B exists alone. where A and B may be singular or plural. The terms “first”, “second”, “third”, “fourth”, etc. (if any) in the specification, claims and drawings of the present application are used to distinguish similar objects, rather than to describe a specific order or sequence.

With the development of computer hardware technology and computer vision technology, current digital human technology has developed rapidly. As an important part of the metaverse, a digital human is also used as an interactive interface with artificial intelligence. This technology has also been applied in many scenarios, including virtual customer service, virtual teachers, and virtual anchors. A virtual digital human is a virtual character with a digital appearance. They are innovative “new species” formed by an integration of computer graphics (CG) technology, motion capture, graphics rendering, holographic projection, and artificial intelligence. The most important thing about the virtual digital human is the interactive function. However, in interactive scenarios such as video communication, the digital human generated by existing technology may synchronously update information of the eyes and mouth, which seriously affects the interactive effect.

Based on the above problems, the present application provides a method for processing the digital human expression, which pre-generates digital human information corresponding to different expressions, and then generates digital human information based on first information and second information of a user, and expression information corresponding to the second information. The generated digital human information may include not only eye and mouth information, but also forehead and face information, making the digital human in an interaction process more vivid and lifelike.

In order to better understand the method for processing the digital human expression, the electronic device and the storage medium provided in the embodiments of the present application, the application scenario of the method for processing the digital human expression of the present application is first described below.

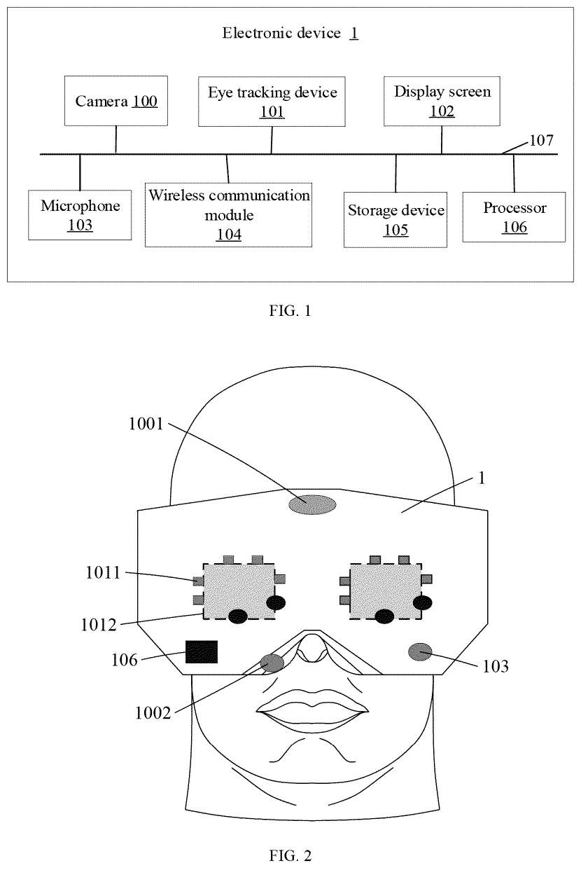

FIG. 1 is a schematic diagram of an application scenario of a method for processing the digital human expression provided in an embodiment of the present application. The method for processing the digital human expression provided in an embodiment of the present application is applied to an electronic device 1, which includes, but is not limited to, a camera 100, an eye tracking device 101, a display screen 102, a microphone 103, a wireless communication module 104, a storage device 105, a processor 106 and a bus 107. The processor 106 is coupled to the camera 100, the eye tracking device 101, the display screen 102, the microphone 103, the wireless communication module 104 and the storage device 105 through the bus 107.

As shown in FIG. 2, the camera 100 includes a first camera 1001 and a second camera 1002. The first camera 1001 is installed in middle of the electronic device 1. When the user wears the electronic device 1, a position of the first camera 1001 on the electronic device 1 is close to a center of the user's forehead. The first camera 1001 is a depth camera, which is used to capture images of an object to be tested and generate a static digital human. Specifically, infrared light is emitted to the object to be tested by a transmitter of the depth camera, and a receiver of the depth camera receives the reflected infrared light and obtains facial information, and generates a digital human based on the facial information. Among them, the facial information includes an area around the eyes, an area around the mouth, the forehead, and facial information.

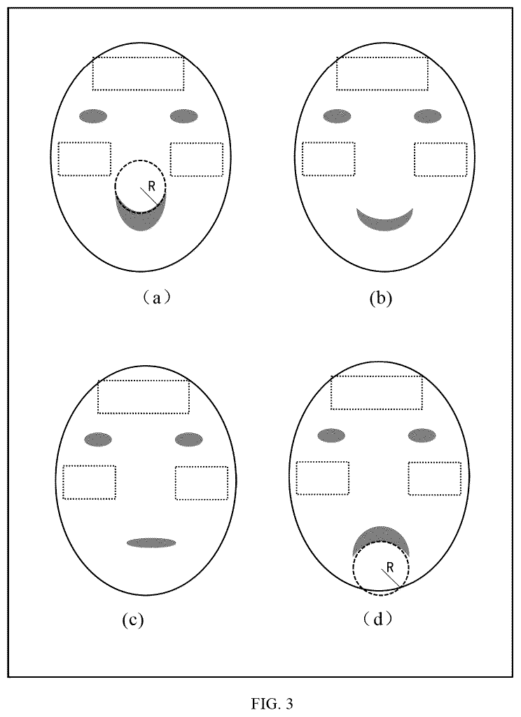

In an embodiment of the present application, the first camera 1001 may be used to capture the face information of the object in different states for multiple times and obtain a digital human in different states. For example, when the object to be tested is in a laughing state, the object to be tested has a first expression, and first face information of the object to be tested in the first expression is obtained through the first camera 1001, and the first digital human is generated according to the first face information, as shown in (a) of FIG. 3. Among them, in the first expression, the eyes of the object to be tested may be in a closed or semi-closed state, and pupils are in an expanded state. Corners of the mouth are raised upward to form a clear smile curve, an upper lip may be slightly raised, and a lower lip may be more relaxed or slightly open, and an overall shape of the mouth will become more open to express a happy emotion. Muscles on the forehead may be slightly wrinkled, and skin on the forehead may produce some horizontal textures due to the upward eyebrows. Cheeks will rise to form “laughing muscle” what we often call and the “laughing muscle” bulges, making the face look fuller and more vivid.

When the object to be tested is in a smiling state, the object to be tested has a second expression, and second face information of the object to be tested in the second expression is obtained through the first camera 1001, and a second digital human is generated according to the second face information, as shown in (b) of FIG. 3. In the second expression, the eyes of the object to be tested are usually kept naturally open, and will not be narrowed or opened wide like when laughing, and the pupils may be slightly dilated, reflecting a happy mood. The corners of the mouth will be slightly raised to form a gentle smile curve, the upper lip may be slightly raised, and the lower lip is relatively relaxed and will not be obviously opened. The muscles on the forehead may be slightly wrinkled, but not as obvious as when laughing. The cheeks will rise to form “laughing muscle” what we often call and the “laughing muscle” bulges, making the face look more friendly and lively.

When the object to be tested is in a non-expression/serious state, the object to be tested has a third expression, and the first camera 1001 obtains third face information of the object to be tested in the third expression, and generates a third digital human according to the third face information, as shown in (c) of FIG. 3. In the third expression, the eyes of the object to be tested usually remain naturally open without obvious changes, the pupils are normal, and do not expand or contract due to emotions. The corners of the mouth remain straight without rising or drooping. The lips are closed, and no teeth are exposed. The muscles on the forehead are relatively relaxed, without obvious wrinkles or tension. The eyebrows remain in a natural state, without rising or wrinkling. The cheeks remain in a natural state, without rising or tightening.

When the object to be tested is in a sad state, the object to be tested has a fourth expression, and the first camera 1001 obtains fourth facial information of the object to be tested in the fourth expression, and generates a fourth digital human according to the fourth facial information, as shown in (d) of FIG. 3. In the fourth expression, the corners of the eyes of the object to be tested may droop. The corners of the mouth may bend downward. The muscles on the forehead may wrinkle slightly, and the facial muscles may relax, making the whole face look more relaxed.

The second camera 1002 is installed below the electronic device 1. When the user wears the electronic device 1, the second camera 1002 is located on the electronic device 1 close to the user's nose. The second camera 1002 is used to obtain information about the user's mouth.

The eye tracking device 101 is installed in the middle of the electronic device 1. When the user wears the electronic device 1, the position of the eye tracking device 101 on the electronic device 1 corresponds to the two eyes of the user. The eye tracking device 101 includes a transmitter 1011 and a third camera 1012. The transmitter 1011 is a light emitting diode (LED) transmitter, which emits infrared light of a specific wavelength (usually 850 nm or 940 nm) to the eye, which will be reflected on the surface of the eyeball (mainly the cornea). Since the cornea has a certain curvature, the reflected light will form a specific light spot pattern. The third camera 1012 is an infrared (IR) camera, which is used to capture high-resolution images of the eye. The eye tracking device 101 analyzes the eye image captured by the third camera 1012, and may identify the position of the light spot and the center position of the pupil. Combined with known light spot pattern and the geometric structure of the eyeball, the movement trajectory and gaze direction of the eyeball may be calculated.

In some embodiments of the present application, the display screen 102 may be a touch screen, which is an inductive touch-sensitive liquid crystal display device. Alternatively, the display screen 102 may also be a non-touch screen. The display screen 102 is used to display images or videos.

In some embodiments of the present application, the microphone 103 is installed below the electronic device 1. When the user wears the electronic device 1, the position of the microphone 103 on the electronic device 1 is close to the user's cheek. The microphone 103 is used to receive voice information of the user. In an embodiment of the present application, the microphone 103 is configured with a speaker, and voice prompt information may be output through the speaker.

In some embodiments of the present application, the wireless communication module 104 may provide one or more wireless communication solutions such as wireless fidelity (Wi-Fi), Bluetooth (BT), mobile communication network, frequency modulation (FM), near field communication technology (NFC), infrared technology, etc.

The storage device 105 may include one or more random access memories (RAM) and one or more non-volatile memories (NVM). The random access memory may be directly read and written by the processor 106, and may be used to store executable programs (such as machine instructions) of an operating system or other running programs, and may also be used to store user and application data.

In some embodiments, the random access memory may include a static random-access memory (SRAM), a dynamic random access memory (DRAM), a synchronous dynamic random access memory (SDRAM), a double data rate synchronous dynamic random access memory (DDR SDRAM), etc.

In some embodiments, the non-volatile memory may also store executable programs and user and application data, etc., and may be loaded into the random access memory in advance for direct reading and writing by the processor 106. The non-volatile memory may include a disk storage device and a flash memory.

In some embodiments of the present application, the storage device 105 is used to store one or more computer programs. The one or more computer programs are configured to be executed by the processor 106. The one or more computer programs include multiple instructions. When the multiple instructions are executed by the processor 106, the method for processing the digital human expression executed on the electronic device 1 may be implemented.

In other embodiments, the electronic device 1 further includes an external memory interface for connecting to an external memory to expand the storage capacity of the electronic device 1.

In some embodiments, the processor 106 may include one or more processing units, for example, the processor 106 may include an application processor (AP), a modem processor, a graphics processor (GPU), an image signal processor (ISP), a controller, a video codec, a digital signal processor (DSP), a baseband processor, and/or a neural network processor (NPU), etc. Different processing units may be independent devices or integrated in one or more processors.

In some embodiments, the processor 106 provides computing and control capabilities. For example, the processor 106 is used to execute a computer program stored in the storage device 105 to implement the above-mentioned method for processing the digital human expression.

In some embodiments, the bus 107 is at least used to provide a channel for mutual communication among the camera 100, the eye tracking device 101, the display screen 102, the microphone 103, the wireless communication module 104, the storage device 105 and the processor 106 of the electronic device 1.

In some embodiments, the electronic device 1 is a pair of smart glasses, which may be an augmented reality (AR) device, a virtual reality (VR) device, or a mixed reality (MR) device.

It is understood that the structure illustrated in the embodiment of the present application does not constitute a specific limitation on the electronic device 1. In other embodiments of the present application, the electronic device 1 may include more or fewer components than shown in the drawings, or combine certain components, or separate certain components, or arrange the components differently. The components shown in the drawings may be implemented in hardware, software, or a combination of software and hardware.

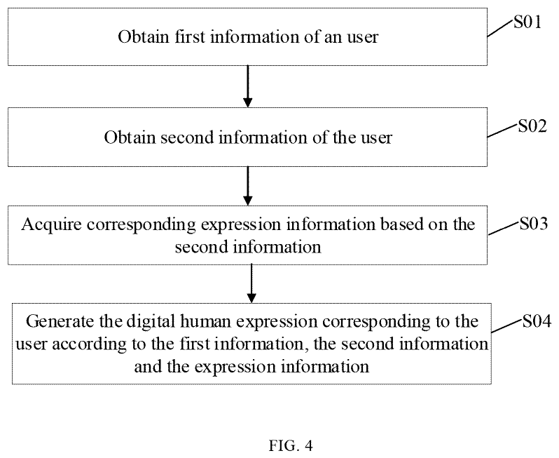

Please refer to FIG. 4, which is a flowchart of the method for processing the digital human expression provided in an embodiment of the present application, which is applied in an electronic device (such as the electronic device in FIG. 2). According to different requirements, the order of the steps in the flowchart may be changed, and some steps may be omitted.

Step S01, the electronic device obtains first information of the user.

In some embodiments of the present application, when a video call or live broadcast is made through the electronic device and other scenes that require interaction with other users, the electronic device will display a digital human image. At this time, the expression of the digital human image is simple, and only eyes and mouth of the user may be updated. In order to enrich the expression of the digital human and make the interaction effect better, the first information of the user may be obtained through the eye tracking device, where the first information includes information around the user's eyes. For example, whether the eyes are closed, whether the pupils are dilated, etc.

Step S02, the electronic device obtains second information of the user.

In the embodiment of the present application, the second information of the user may be obtained through the second camera of the electronic device. The second information includes information around the user's mouth, for example, whether the mouth is closed, and whether the corners of the mouth are raised.

Step S03, the electronic device acquires corresponding expression information based on the second information.

In an embodiment of the present application, a mouth shape image of the user is obtained through the second camera, and corresponding expression information is acquired based on the mouth shape of the mouth shape image.

In some embodiments, the electronic device acquires corresponding expression information based on the second information by obtaining a circle based on the mouth shape and determining whether an overlapping portion between an arc corresponding to the mouth shape and the circle is greater than a first threshold. In response that the overlapping portion is less than or equal to the first threshold, the electronic device determines that the expression of current user is corresponding to a third digital human. In response that the overlapping portion is greater than the first threshold, the electronic device determines whether a center of the circle is located above the arc. In response that the center of the circle is located below the arc, the electronic device determines that the expression of the current user is corresponding to a fourth digital human. In response that the center of the circle is located above the arc, the electronic device determines whether a radius of the circle is equal to a preset radius. In response that the radius of the circle is equal to the preset radius, the electronic device determines that the expression of the current user corresponds to a digital human associated with the preset radius.

In an embodiment of the present application, the electronic device determines whether a radius of the circle is equal to a preset radius by determining whether an absolute value of a difference between the radius of the circle and the preset radius is less than or equal to a first error, or an absolute value of a difference between a ratio of the radius of the circle to the preset radius and one is less than or equal to a second error. In response that the absolute value of the difference between the radius of the circle and the preset radius is less than or equal to the first error, the electronic device determines that the radius of the circle is equal to the preset radius; in response that the absolute value of the difference between the radius of the circle and the preset radius is greater than the first error, the electronic device determines that the radius of the circle is different from the preset radius. In response that the absolute value of the difference between the ratio of the radius of the circle to the preset radius and one is less than or equal to the second error, the electronic device determines that the radius of the circle is equal to the preset radius; in response that the absolute value of the difference between the ratio of the radius of the circle to the preset radius and one is greater than the second error, the electronic device determines that the radius of the circle is different from the preset radius.

In an embodiment of the present application, in response that the radius of the circle is the same as the preset radius, the electronic device determines that the expression of the current user corresponding to the digital human associated with the preset radius includes: in response that the radius of the circle is the same as the preset radius of the arc corresponding to the mouth shape of the first digital human in the database, the electronic device determines that the expression of the user corresponds to the first digital human; in response that the radius of the circle is the same as the preset radius of the arc corresponding to the mouth shape of the second digital human in the database, the electronic device determines that the expression of the user corresponds to the second digital human.

In an embodiment of the present application, the first expression corresponding to the first digital human is laughter. The second expression corresponding to the second digital human is smile. The third expression corresponding to the third digital human is expressionless/serious. And the fourth expression corresponding to the fourth digital human is sadness.

Step S04, the electronic device generates the digital human expression corresponding to the user according to the first information, the second information and the expression information.

In an embodiment of the present application, in response that the overlapping portion of the arc corresponding to the mouth shape and the circle is less than or equal to the first threshold, it is determined that the arc corresponding to the mouth shape may not be found, the user is currently in an expressionless/serious state. The electronic device determines the expression of the current user corresponding to a third digital human based on the second information and obtains the forehead and facial information of the third digital human, and generates the digital human expression corresponding to the user according to the first information and the second information and the forehead and facial information of the third digital human.

In response that the center of the circle is located below the arc, it is determined that the user is currently in a sad state. The electronic device determines the expression of the current user corresponding to a fourth digital human based on the second information and obtains the forehead and facial information of the fourth digital human, and generates the digital human expression corresponding to the user according to the first information and the second information and the forehead and facial information of the fourth digital human.

In response that the radius of the circle is the same as the preset radius of the arc corresponding to the mouth shape of the first digital human in the database, it is determined that the expression of the current user is the first digital human, and the expression information of the digital human is generated according to the first information, the second information and the expression corresponding to the first digital human. In response that the radius of the circle is the same as the preset radius of the arc corresponding to the mouth shape of the second digital human in the database, the expression information of the digital human is generated according to the first information, the second information and the expression corresponding to the second digital human.

In some embodiments, the method further includes displaying the digital human expression on the display screen. For example, when the user interacts with other users, the electronic device displays the digital human expression on the display screen.

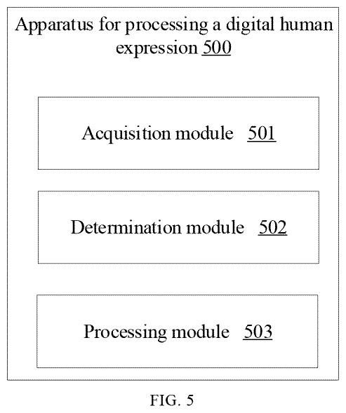

FIG. 5 is a schematic diagram of a structure of an apparatus for processing a digital human expression provided in an embodiment of the present application. The apparatus for processing the digital human expression 500 may include a plurality of functional modules composed of computer program segments. The computer programs of the various program segments of the apparatus for processing the digital human expression 500 may be stored in a storage device of an electronic device and executed by at least one processor to perform (see FIG. 4 for details) the function of processing the digital human expression.

In this embodiment, the apparatus for processing the digital human expression 500 may be divided into multiple functional modules according to the functions it perform. The functional modules may include: an acquisition module 501, a determination module 502 and a processing module 503. The module referred to in the present application refers to a series of computer program segments that may be executed by at least one processor and may complete fixed functions, which are stored in a storage device. In some embodiments, the apparatus for processing the digital human expression 500 may be used to implement the method for processing the digital human expression shown in FIG. 4. As shown in FIG. 5, the apparatus for processing the digital human expression 500 is applied to an electronic device (the electronic device shown in FIG. 3), and apparatus for processing the digital human expression 500 includes: the acquisition module 501 is used to acquire the first information of the user. The acquisition module 501 is also used to acquire the second information of the user. The determination module 502 is used to determine corresponding expression information based on the second information. And the processing module 503 is used to generate the expression of the digital human according to the first information, the second information and the expression information.

In some embodiments, the determination module 502 is further configured to acquire corresponding expression information based on mouth shape of the second information.

In some embodiments, the determination module 502 is further used to obtain a circle based on the mouth shape, determine whether an overlapping portion between an arc corresponding to the mouth shape and the circle is greater than a first threshold, determine whether a center of the circle is located above the arc in response to the overlapping portion being greater than the first threshold, and determine whether a radius of the circle is equal to a preset radius in response to the center of the circle being located above the arc, and in response to the radius of the circle being equal to the preset radius, determine that an expression of the user is corresponding to a digital human associated with the preset radius.

In some embodiments, the determination module 502 is further used to determine that the expression of the user corresponds to a first digital human, in response to the radius of the circle being the same as the preset radius of the arc, which corresponds to the mouth shape of the first digital human in a database, and determine that the expression of the user corresponds to a second digital human, in response to the radius of the circle being the same as the preset radius of the arc, which corresponds to the mouth shape of the second digital human in the database.

In some embodiments, the determination module 502 is further configured to determine that the expression of the user corresponds to a third digital human in response to the overlapping portion being less than or equal to the first threshold.

In some embodiments, the determination module 502 is further configured to determine that the expression of the current user corresponds to a fourth digital human in response to the center of the circle being located below the arc.

In some embodiments, an absolute value of a difference between the radius of the circle and the preset radius is less than or equal to a first error; or an absolute value of a difference between a ratio of the radius of the circle to the preset radius and one is less than or equal to a second error.

An embodiment of the present application further provides a computer-readable storage medium, on which a computer program is stored. The computer program includes program instructions. The method implemented when the program instructions are executed may refer to the methods in the above-mentioned embodiments of the present application.

An embodiment of the present application provides a computer program product, which includes a computer program. When the computer program runs on a processor, the processor executes the method for processing the digital human expression described in any possible implementation manner above.

The computer-readable storage medium may be an internal memory of the computer device described in the above embodiment, such as a hard disk or memory of the computer device. The computer-readable storage medium may also be an external storage device of the computer device, such as a plug-in hard disk, a smart memory card (SMC), a secure digital (SD) card, a flash card, etc., equipped on the electronic device.

In some embodiments, the computer-readable storage medium may include a program storage area and a data storage area, wherein the program storage area may store an operating system, an application required for at least one function, etc.; the data storage area may store data created according to the use of the computer device, etc.

In the above embodiments, the description of each embodiment has its own emphasis. For parts that are not described or recorded in detail in a certain embodiment, reference may be made to the relevant descriptions of other embodiments.

Those of ordinary skill in the art will appreciate that the units and algorithm steps of each example described in conjunction with the embodiments disclosed herein may be implemented in electronic hardware, or a combination of computer software and electronic hardware. Whether these functions are performed in hardware or software depends on the specific application and design constraints of the technical solution. Professional and technical personnel may use different methods to implement the described functions for each specific application, but such implementation should not be beyond the scope of this application.

In some embodiments provided in the present application, the disclosed devices/terminal equipment and methods may be implemented in other ways. For example, the device/terminal equipment embodiments described above are only schematic. For example, the division of the modules or units is only a logical function division. There may be other division methods in actual implementation, such as multiple units or components may be combined or integrated into another system, or some features may be ignored or not executed. Another point is that the mutual coupling or direct coupling or communication connection shown or discussed may be through some interfaces, indirect coupling or communication connection of devices or units, which may be electrical, mechanical or other forms.

The units described as separate components may or may not be physically separated, and the components shown as units may or may not be physical units, that is, they may be in one place or distributed on multiple network units. Some or all the units may be selected according to actual needs to achieve the purpose of the solution of this embodiment.

The embodiments described above are only used to illustrate the technical solutions of the present application, rather than to limit them. Although the present application has been described in detail with reference to the embodiments, a person skilled in art should understand that the technical solutions described in the embodiments may still be modified, or some of the technical features may be replaced by equivalents. Such modifications or replacements do not deviate the essence of the corresponding technical solutions from the spirit and scope of the technical solutions of the embodiments of the present application and should all be included in the protection scope of the present application.

What is claimed is:

1. A method for processing a digital human expression, applied to an electronic device, the method comprising:
obtaining first information of a user;
obtaining second information of the user;
acquiring corresponding expression information based on the second information; and
generating the digital human expression corresponding to the user according to the first information, the second information, and the expression information.

2. The method according to claim 1, wherein acquiring corresponding expression information based on the second information comprises:
acquiring the corresponding expression information based on a mouth shape of the second information.

3. The method according to claim 2, wherein acquiring corresponding expression information based on the mouth shape of the second information comprises:
obtaining a circle based on the mouth shape;
determining whether an overlapping portion between an arc corresponding to the mouth shape and the circle is greater than a first threshold;
in response to the overlapping portion being greater than the first threshold, determining whether a center of the circle is located above the arc;
in response to the center of the circle being located above the arc, determining whether a radius of the circle is equal to a preset radius;
in response to the radius of the circle being equal to the preset radius, determining that an expression of the user corresponds to a digital human associated with the preset radius.

4. The method according to claim 3, wherein determining that the expression of the user corresponds to the digital human associated with the preset radius comprises:
determining that the expression of the user corresponds to a first digital human, in response to the radius of the circle being the same as the preset radius of the arc, which corresponds to a mouth shape of the first digital human in a database;
determining that the expression of the user corresponds to a second digital human, in response to the radius of the circle being the same as the preset radius of the arc, which corresponds to a mouth shape of the second digital human in the database.

5. The method according to claim 3, further comprising:
in response to the overlapping portion being less than or equal to the first threshold, determining that the expression of the user corresponds to a third digital human.

6. The method according to claim 3, further comprising:
in response to the center of the circle being located below the arc, determining that the expression of the user corresponds to a fourth digital human.

7. The method according to claim 4, wherein determining that the radius of the circle is equal to the preset radius comprises:
determining that an absolute value of a difference between the radius of the circle and the preset radius is less than or equal to a first error; or
determining that an absolute value of a difference between a ratio of the radius of the circle to the preset radius and one is less than or equal to a second error.

8. An electronic device comprising:
a storage device;
at least one processor; and
the storage device storing one or more programs that, when executed by the at least one processor, cause the at least one processor to:
obtain first information of a user;
obtain second information of the user;
acquire corresponding expression information based on the second information; and
generate a digital human expression corresponding to the user according to the first information, the second information, and the expression information.

9. The electronic device according to claim 8, wherein the at least one processor acquires corresponding expression information based on the second information by:
acquiring the corresponding expression information based on a mouth shape of the second information.

10. The electronic device according to claim 9, wherein the at least one processor acquires corresponding expression information based on the mouth shape of the second information by:
obtaining a circle based on the mouth shape;
determining whether an overlapping portion between an arc corresponding to the mouth shape and the circle is greater than a first threshold;
in response to the overlapping portion being greater than the first threshold, determining whether a center of the circle is located above the arc;
in response to the center of the circle being located above the arc, determining whether a radius of the circle is equal to a preset radius;
in response to the radius of the circle being equal to the preset radius, determining that an expression of the user corresponds to a digital human associated with the preset radius.

11. The electronic device according to claim 10, wherein the at least one processor determines that the expression of the user corresponds to the digital human associated with the preset radius by:
determining that the expression of the user corresponds to a first digital human, in response to the radius of the circle being the same as the preset radius of the arc, which corresponds to a mouth shape of the first digital human in a database;
determining that the expression of the user corresponds to a second digital human, in response to the radius of the circle being the same as the preset radius of the arc, which corresponds to a mouth shape of the second digital human in the database.

12. The electronic device according to claim 10, wherein the at least one processor is further caused to:
in response to the overlapping portion being less than or equal to the first threshold, determine that the expression of the user corresponds to a third digital human.

13. The electronic device according to claim 10, wherein the at least one processor is further caused to:
in response to the center of the circle being located below the arc, determine that the expression of the current user corresponds to a fourth digital human.

14. The electronic device according to claim 11, wherein the at least one processor determines that the radius of the circle is equal to the preset radius by:
determining that an absolute value of a difference between the radius of the circle and the preset radius is less than or equal to a first error; or
determining that an absolute value of a difference between a ratio of the radius of the circle to the preset radius and one is less than or equal to a second error.

15. A non-transitory storage medium having instructions stored thereon, when the instructions are executed by a processor of an electronic device, the processor is caused to perform a method for processing a digital human expression, wherein the method comprises:
obtaining first information of a user;
obtaining second information of the user;
acquiring corresponding expression information based on the second information; and
generating the digital human expression corresponding to the user according to the first information, the second information, and the expression information.

16. The non-transitory storage medium according to claim 15, wherein acquiring corresponding expression information based on the second information comprises:
acquiring the corresponding expression information based on a mouth shape of the second information.

17. The non-transitory storage medium according to claim 16, wherein acquiring corresponding expression information based on the mouth shape of the second information comprises:
obtaining a circle based on the mouth shape;
determining whether an overlapping portion between an arc corresponding to the mouth shape and the circle is greater than a first threshold;
in response to the overlapping portion being greater than the first threshold, determining whether a center of the circle is located above the arc;
in response to the center of the circle being located above the arc, determining whether a radius of the circle is equal to a preset radius;
in response to the radius of the circle being equal to the preset radius, determining that an expression of the user corresponds to a digital human associated with the preset radius.

18. The non-transitory storage medium according to claim 17, wherein determining that the expression of the user corresponds to the digital human associated with the preset radius comprises:
determining that the expression of the user corresponds to a first digital human, in response to the radius of the circle being the same as the preset radius of the arc, which corresponds to a mouth shape of the first digital human in a database;
determining that the expression of the user corresponds to a second digital human, in response to the radius of the circle being the same as the preset radius of the arc, which corresponds to a mouth shape of the second digital human in the database.

19. The non-transitory storage medium according to claim 17, wherein the method further comprises:
in response to the overlapping portion being less than or equal to the first threshold, determining that the expression of the user corresponds to a third digital human.

20. The non-transitory storage medium according to claim 17, wherein the method further comprises:
in response to the overlapping portion being less than or equal to the first threshold, determining that the expression of the user corresponds to a third digital human.
